(19) United States
(12) Patent Application Publication
(10) Pub. No.: US 2024/0160413 A1
(43) Pub. Date: May 16, 2024

(54) Application Development Platform, Micro-program Generation Method, and Device and Storage Medium

(71) Applicant: BOE Technology Group Co., Ltd., Beijing (CN)

(72) Inventor: Sujia JIANG, Beijing (CN)

(21) Appl. No.: 18/282,228

(22) PCT Filed: Jan. 10, 2023
(86) PCT No.: PCT/CN2023/071507

§ 371 Date: Sep. 15, 2023

(30) Foreign Application Priority Data
Jan. 24, 2022 (CN) 202210082340.8

(51) Int. Cl. G06F 8/30

(52) U.S. Cl. CPC G06F 8/30

(57) ABSTRACT

An application development platform, a micro-program generation method, and a device and a storage medium. The application development platform comprises: a panel library, a micro-program center and a visualized configuration system, wherein the panel library is configured to store panels. The micro-program center is configured to: obtain a page design image which comprises panel image information; determine whether there is a panel in the panel library that matches the panel image information; if there is said panel in the panel library, acquire said panel as a target panel; and generate a micro-program by means of the visualized configuration system and on the basis of the target panel.

### CROSS-REFERENCE TO RELATED APPLICATIONS

The present application is a U.S. National Phase Entry of International Application No. PCT/CN2023/071507 having an international filing date of Jan. 10, 2023, which claims priority to Chinese patent application No. 202210082340.8, filed to the CNIPA on Jan. 24, 2022 and titled “Application Development Platform, Micro-program Generation Method, Device, and Storage Medium”. The contents of the above-identified applications are hereby incorporated by reference.

### TECHNICAL FIELD

Embodiments of the present disclosure relate to, but are not limited to, the field of computer technologies, in particular to an application development platform, a micro-program generation method, a device, and a storage medium.

### BACKGROUND

In a development process, design images designed by designers are usually taken as a basis. With iteration of business development requirements and the designers' strict control over design drafts, how to save time of design and development and cost of communication with each other has increasingly become a focus of development and design. However, at present, especially when there is a run on design manpower, the designers cannot give to other personnel through fine granularity development, which leads to a need for the designers to repeat their work with other personnel in every development process, thus wasting a lot of development costs.

### SUMMARY

The following is a summary of subject matter described herein in detail. The summary is not intended to limit the protection scope of claims.

In a first aspect, an embodiment of the present disclosure provides an application development platform, including: a panel library, a micro-program center, and a visualized configuration system, wherein the panel library is configured to store a panel; and the micro-program center is configured to obtain a page design image including panel image information; determine whether there is a panel that matches the panel image information in the panel library; if there is a panel that matches the panel image information in the panel library, acquire the panel that matches the panel image information as a target panel; and generate a micro-program based on the target panel through the visualized configuration system.

In a second aspect, an embodiment of the present disclosure provides a micro-program generation method, which is applied to an application development platform, wherein the method includes: obtaining a page design image including panel image information; determining whether there is a panel that matches the panel image information in a panel library; if there is a panel that matches the panel image information in the panel library, acquiring the panel that matches the panel image information as a target panel; and generating a micro-program based on the target panel through a visualized configuration system.

In a third aspect, an embodiment of the present disclosure provides a computer device, including: a processor and a memory storing a computer program that is runnable on the processor, wherein acts of the micro-program generation method in the above embodiment are implemented when the processor executes the program.

In a fourth aspect, an embodiment of the present disclosure provides a computer-readable storage medium, including a stored program, wherein acts of the micro-program generation method in the above embodiment are implemented when the program is run.

Other features and advantages of the present disclosure will be set forth in following specification, and partially become apparent from the specification or are understood by implementing the present disclosure. Other advantages of the present disclosure may be achieved and obtained through solutions described in the specification and drawings.

Other aspects may be understood upon reading and understanding the drawings and detailed description.

### BRIEF DESCRIPTION OF DRAWINGS

Accompanying drawings are used for providing understanding of technical solutions of the present disclosure, and constitute a part of the specification. They are used for explaining the technical solutions of the present disclosure together with the embodiments of the present disclosure, but do not constitute limitations on the technical solutions of the present disclosure. Shapes and sizes of components in the drawings do not reflect actual scales, and are only intended to schematically illustrate contents of the present disclosure.

FIG. 1 is a schematic diagram of an architecture of an application development platform according to an exemplary embodiment of the present disclosure.

FIG. 2 is a first flowchart of a micro-program generation method according to an exemplary embodiment of the present disclosure.

FIG. 3 is a schematic diagram of a page design image according to an exemplary embodiment of the present disclosure.

FIG. 4 is a schematic diagram of a display interface of a title panel according to an exemplary embodiment of the present disclosure.

FIG. 5 is a second flowchart of a micro-program generation method according to an exemplary embodiment of the present disclosure.

FIG. 6 is a schematic diagram of a structure of a computer device according to an exemplary embodiment of the present disclosure.

### DETAILED DESCRIPTION

Multiple embodiments are described herein, but the description is exemplary rather than restrictive, and there may be more embodiments and implementation solutions within the scope contained in the embodiments described herein. Although many possible feature combinations are shown in the drawings and discussed in exemplary implementation modes, many other combinations of disclosed features are also possible. Unless expressly limited, any feature or element of any embodiment may be used in combination with, or may replace, any other feature or element in any other embodiment.

When describing a representative embodiment, in the specification, a method and/or process may be presented as a specific order of acts. However, to an extent that the method or the process does not depend on the specific order of the acts described herein, the method or the process should not be limited to the acts with the specific order. Other orders of acts may also be possible, as will be understood by those skilled in the art. Therefore, a specific order of acts illustrated in the specification should not be interpreted as a limitation on claims. Moreover, claims directed to the method and/or process should not be limited to performing their acts in a described order, and those skilled in the art may readily understand that these orders may be varied and still remain within the spirit and scope of the embodiments of the present disclosure.

Unless otherwise defined, technical terms or scientific terms used in the embodiments of the present disclosure shall have common meanings understood by people with ordinary skills in the field to which the present disclosure pertains. “First”, “second”, and similar words used in the embodiments of the present disclosure do not represent any order, quantity, or importance, but are only used for distinguishing different components. A word such as “include” or “contain” means that an element or object appearing before the word includes an element or object listed after the word or its equivalents and does not exclude another element or object. “Connection”, “mutual connection”, or a similar word is not limited to a physical or mechanical connection, but may include an electrical connection, whether direct or indirect.

(1) Sketch, Sketch Plug-In, and SketchTool

Sketch is a design tool.

Sketch plug-in refers to Sketch software set in a form of plug-in. For example, a Sketch resource may include: a page, a Canva, an Artboard, and a Layer, etc. Among them, the Canva refers to a drawing region in Sketch used for drawing visual elements such as graphics, characters, and images, to form a page. A size of the Canva may be infinite, and a user may drag it in any direction at will. One Artboard or multiple Artboards may be inserted on one Canva. An Artboard refers to a designated drawing region in a Canva, in which one or more combination of visual elements such as graphics, characters, and images may be drawn to form a panel. A size of the Artboard is limited, and the Artboard may have a fixed border. The Layer is the most basic unit in Sketch, and each object (such as a Canva and an Artboard) in Sketch has its own Layer. The Layer may include: a text layer, and a graphic layer, etc. A graphic with a complex shape may be formed by combining multiple graphics with simple shapes, and correspondingly, a graphic layer with a complex shape may be formed by combining multiple graphic layers with simple shapes.

(2) Operating System (OS)

An operating system is a computer program that manages computer hardware and software resources. The operating system may handle basic transactions such as managing and configuring a memory, determining a priority order for system resource supply and demand, controlling input and output devices, or operating networks and managing file systems. For example, a common mobile operating system at present may include Android operating system, or iOS operating system, etc., and common server-side and computer-side operating systems at present may include Linux operating system, Windows operating system, or UNIX operating system, etc. Correspondingly, applications may include: Android applications, iOS applications, or Windows applications, etc.

(3) Flutter, Domain Specific Language (DSL), and JavaScript Object Notation (JSON)

Flutter is a cross-platform User Interface (UI) development framework, which may build high-quality native user interfaces on multiple operating systems through a set of code bases. For example, the multiple operating systems may include Android operating system, or iOS operating system, etc. When an Application (APP) is developed based on an operating system, a user interface may be developed by combining Flutter. In a practical application stage of the APP, the user interface may be displayed by combining tool classes provided by Flutter with tool classes provided by the operating system. A cross-platform user interface may refer to a user interface suitable for a platform such as Android operating system, iOS operating system, or Windows operating system.

DSL is a syntax rule that enables domain experts to describe rules in the domain in a simple programming way.

JSON is a lightweight data format that is easy for users to read and write, and easy for machine parsing and generation.

(4) Application (APP), Interface, and Page

An application, i.e., an application program, refers to a computer program intended to complete one or more specific tasks. It runs in a user mode, may interact with a user, and generally has a visual user interface. For example, the application may include, but is not limited to: an application suitable for an operating system such as iOS, Android, Web, Windows, macOS, or Linux. For example, one application may implement one or more functions, and one function may be split into one or more sub-functions. For example, one application may include multiple interfaces. For example, one application may include multiple pages.

An interface is a medium interface for transmitting and exchanging information between a user and a machine (for example, a computer device), and is a collection of supporting software, hardware, and methods for bidirectional information interaction between a user and a machine (for example, a computer device). It realizes conversion between an internal form of information and a form acceptable to the user. A common expression form of interface is a Graphic User Interface (GUI). The graphic user interface refers to an operation-related user interface that is displayed in a graphical way. For example, one interface may include one or more page implementations. For example, switching between multiple pages may be achieved by bonding components (such as a navigation bar) to multiple pages.

A page refers to content displayed in an interface during interaction between a user and a machine.

(5) Low Code

Low code means that in a process where a user relies on an application development platform to rapidly create an application, the user (e.g., a developer) may complete most of development work through a more efficient visual development method such as dragging, clicking-and-selecting, or parameter configuration, without a lot of code writing.

(6) Module, Center, and System

A module, a center, and a system may refer to a combination of any known or later developed hardware, software, firmware, artificial intelligence, fuzzy logic, or hardware or/and software codes, which can perform relevant functions.

An exemplary embodiment of the present disclosure provides an application development platform. The application development platform is a visual development system based on Flutter and Sketch that solves a problem of human efficiency with low code engineering, which may provide management services for products such as panels, micro-programs or applications, provide visual configuration services, provide services for packaging based on micro-programs to form cross-platform applications, etc., and can rapidly generate applications suitable for different operating systems based on micro-programs. Therefore, it can improve development efficiency and reduce a development cost, and has a wide application prospect.

In an exemplary embodiment, the application development platform may include: a panel library, a micro-program center, and a visualized configuration system, wherein the panel library is configured to store panels; and the micro-program center is configured to obtain a page design image including panel image information, determine whether there is a panel that matches the panel image information in the panel library, and if there is a panel that matches the panel image information in the panel library, acquire the panel that matches the panel image information as a target panel, and generate a micro-program based on the target panel through the visualized configuration system. Thus, a micro-program is generated through a panel that matches panel image information of a page design image in a panel library, which is convenient for a user (e.g., a developer, a product manager, a project manager, or a tester) to quickly convert the page design image into the micro-program. In this way, when the micro-program is applied to a scene of application development, development efficiency is improved, a development cost can be reduced, and a threshold of use is lowered, leading to a wide application prospect.

In an exemplary embodiment, the application development platform may further include: a component center configured to store components; and the micro-program center is configured to display the target panel through the visualized configuration system, and perform a configuration operation on the target panel in response to a user operation to generate a micro-program, wherein the configuration operation includes at least one of display parameter configuration, data bonding, event bonding, and component bonding.

In an exemplary embodiment, the micro-program center is further configured to acquire a preset blank panel from the panel library if there is no panel that matches the panel image information in the panel library, wherein the preset blank panel includes at least one of a preset blank text panel and a preset blank picture panel; and generate a target panel based on the panel image information and the preset blank panel.

In an exemplary embodiment, the micro-program center is further configured to determine panel type information based on the panel image information; based on the panel type information, search whether there is a panel that corresponds to the panel type information in a preset panel library; and according to a search result, determine whether there is a panel that matches the panel image information in the preset panel library.

In an exemplary embodiment, the micro-program center is further configured to determine whether the panel type information is a text panel type; if the panel type information is a text panel type, extract text information from the panel image information and insert the text information into a preset blank text panel to generate a target panel; and if the panel type information is not a text panel type, insert the panel image information into a preset blank picture panel to generate a target panel.

In an exemplary embodiment, the application development platform may further include: a product center configured to package a micro-program to generate a cross-platform application. When run on different operating systems, the cross-platform application generates pages including the target panel that are suitable for different operating systems.

For example, the cross-platform application refers to an application suitable for a platform such as iOS, Android, Web, Windows, macOS, or Linux. Here, the embodiment of the present disclosure is not limited thereto.

In an exemplary embodiment, the product center is configured to acquire one or more micro-programs from the micro-program center; and generate a cross-platform application corresponding to a preset operating system based on the one or more micro-programs.

For example, the preset operating system may be preset by a user or may be automatically set by the application development platform. Here, the embodiment of the present disclosure is not limited thereto.

For example, when a user expects to generate an iOS application relying on the application development platform, the preset operating system may be iOS operating system, and at this time, the application development platform may generate an iOS application according to a micro-program. When the user expects to generate an Android application relying on the application development platform, the preset operating system may be iOS operating system, and at this time, the application development platform may generate an Android application according to a micro-program.

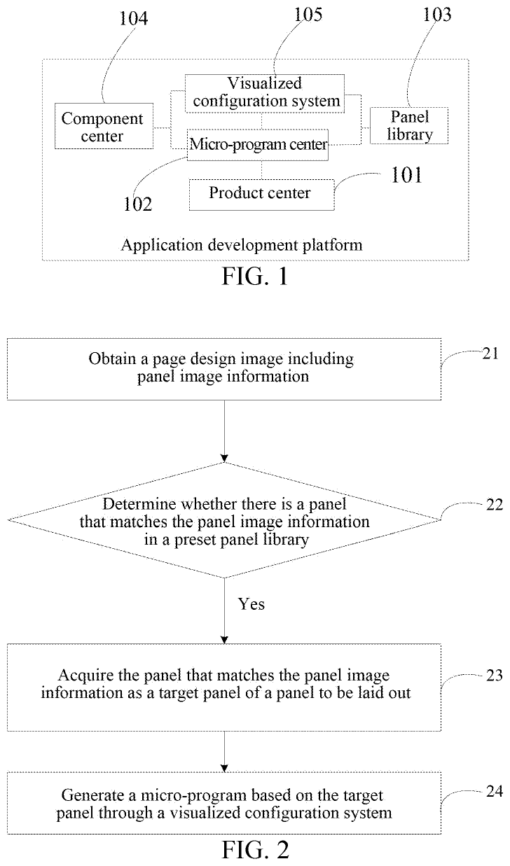

FIG. 1 is a schematic diagram of an architecture of an application development platform according to an exemplary embodiment of the present disclosure. As shown in FIG. 1, the application development platform may include: a product center 101, a micro-program center 102, a panel library 103, a component center 104, and a visualized configuration system 105.

In an exemplary embodiment, the product center may provide services of application generation, management, search, or storage. For example, a service of application generation may include: a service of packaging based on a micro-program to form a cross-platform application. The micro-program center may provide services of micro-program generation, management, search, and storage, etc. The panel library may provide services of panel generation, management, search, and storage, etc. The component center may provide services of component generation, management, search, and storage, etc. The visualized configuration system may provide visual configuration services for products such as interfaces, pages, panels, or components.

In an exemplary embodiment, the visualized configuration system may refer to a module in a mobile application development platform that is based on a Flutter and DSL framework, with an upper layer involved with Sketch plug-in, and capable of providing services such as visual configuration page components (e.g., a panel). Thus, a user (e.g., a developer) may complete most of development work through a more efficient visual development method such as dragging, clicking-and-selecting, or parameter configuration.

In an exemplary embodiment, the micro-program may refer to a reusable file developed on a basis of Flutter dynamic DSL framework development, and may include code blocks of one or more cross-platform pages. When the micro-program is run, one or more cross-platform pages may be achieved, and a cross-platform page may refer to a page developed on a basis of a Flutter dynamic DSL framework, thus classification management may be facilitated and workload of repeated development may be avoided. For example, one micro-program may be packaged separately to generate an application, or multiple micro-programs may be packaged together to generate an application. For example, taking a smart city as an example, according to a scene, it may be divided into functions such as a smart park, a smart office, a smart home, or smart transportation. A smart city application may be generated by packaging micro-programs such as a micro-program that achieves a smart park and a micro-program that achieves a smart office. For another example, taking a micro-program that achieves a punch-in function as an example, a conference application may provide an enterprise employee sign-in service by packaging a micro-program that achieves the punch-in function, or a factory application may provide a factory visitor management service by packaging a micro-program that achieves a punch-in function.

In an exemplary embodiment, the panel library may refer to a collection of panels. A panel may refer to a reusable page component developed based on a Flutter dynamic DSL framework, and may refer to a code block that achieves a panel, thus classification management may be facilitated and workload of repeated development may be avoided. For example, a panel may refer to a visual interface element in a page. For example, a panel may include, but is not limited to: a line chart panel, a Pie panel, a list panel, an annular scale distribution panel, a bar chart panel, a title panel, a carousel chart panel, a button panel, a system announcement panel, or a text panel, etc. For example, one panel may achieve one page separately by layout, and multiple panels may achieve one page by layout or splicing.

In an exemplary embodiment, a component (also referred to as a control) may include, but is not limited to: a drop-down list box, a text input box, a button, a navigation bar (TabBar), a scroll bar, or a check box, etc., and has a function of execution or a function of triggering code to run through an “event” and complete a response, e.g., executing a function of interaction with a user. For example, display of a panel may be controlled by bonding a component to the panel. For example, a drop-down list box is bound to a line chart panel, and a user who views a line chart may select data that the user is more concerned about through the drop-down list box, so that the line chart panel only displays the data that the user is more concerned about. For example, switching between multiple pages may be controlled by bonding components to the multiple pages.

For example, one interface may include one or more page implementations, and multiple pages may be switched through an interface component such as a navigation bar. For example, one page may include one or more panels. For example, one panel may be bound to one or more components. For example, multiple pages may be bound to multiple components.

An exemplary embodiment of the present disclosure provides a micro-program generation method, which may be applied to the application development platform in one or more of the above exemplary embodiments. The micro-program generation method provided by the embodiment of the present disclosure is described below in combination with the above application development platform.

FIG. 2 is a first flowchart of a micro-program generation method according to an exemplary embodiment of the present disclosure. As shown in FIG. 2, the micro-program generation method may include following acts.

Act 21: obtaining a page design image including panel image information.

Act 22: determining whether there is a panel that matches the panel image information in a panel library.

Act 23: if there is a panel that matches the panel image information in the panel library, acquiring the panel that matches the panel image information as a target panel.

Act 24: generating a micro-program based on the target panel through a visualized configuration system.

Thus, a micro-program is generated through a panel that matches panel image information of a page design image in a panel library, which is convenient for a user (e.g., a developer, a product manager, a project manager, or a tester) to quickly convert a page design image into a micro-program. In this way, when the micro-program is applied to a scene of developing an application, development efficiency is improved, a development cost can be reduced, and a threshold of use is lowered, having a wide application prospect.

In an exemplary embodiment, the page design image may refer to a final design drawing of a certain page of an application (APP), or may refer to a design draft of a certain page of an application (APP), etc., here the embodiment of the present disclosure is not limited thereto. For example, the page design image may refer to an image designed by a User Interface (UI) designer for a certain application scene of an application (APP) using a UI design tool (such as Sketch tool or PhotoShop tool). For example, the UI designer may design a page design image by using a UI design tool according to a page development design idea of an application, and then upload the page design image to the micro-program center through an entry provided by the micro-program center of the application development platform. In this way, the micro-program center obtains the page design image.

In an exemplary embodiment, a data format of the page design image may include, but is not limited to, a format such as PNG, JPEG, or JPG. Here, the embodiment of the present disclosure is not limited thereto.

In an exemplary embodiment, the panel image information may refer to an image region where a panel is located in the page design image. One page may include one or more panels, and correspondingly, a page design image corresponding to one page may include panel image information corresponding to all panels in the page. That is, depending on a quantity of panels in the page, one page design image may include one piece of panel image information or multiple pieces of panel image information. In addition, a page design image corresponding to one page may further include, in addition to panel image information of a panel in the page, layout information of the panel in the page, for example, a relative position relationship of multiple panels in the page, or hierarchical structure information, etc.

In an exemplary embodiment, the panel may include: a line chart panel, a Pie panel, a list panel, an annular scale distribution panel, a bar chart panel, a title panel, a carousel chart panel, a system announcement panel, a picture panel, or a text panel, etc. Correspondingly, panel image information may include: image information of a line chart panel, image information of a Pie panel, image information of a list panel, image information of an annular scale distribution panel, image information of a title panel, image information of a carousel chart panel, image information of a button panel, image information of a system announcement panel, or image information of a text panel, etc. Here, the embodiment of the present disclosure is not limited thereto.

In an exemplary embodiment, a data format of the micro-program may be a JavaScript Object Notation (JSON) data format based on DSL description.

In an exemplary embodiment, content of the micro-program may include, but is not limited to: basic information, DSL-JSON data of a page, and visual configuration screenshots of the micro-program, etc., wherein the basic information includes, but is not limited to: a name, a version number, an application type, a resolution, and a service attribute, etc. DSL-JSON data of the page may include, but is not limited to: JSON data of all panels in the page (i.e., strings describing panels) and an entire DSL-JSON file of layout information of the page. The layout information of the page may include: position information of each panel in the page, hierarchical structure information between all panels in the page, or hierarchical structure information between multiple pages, etc.

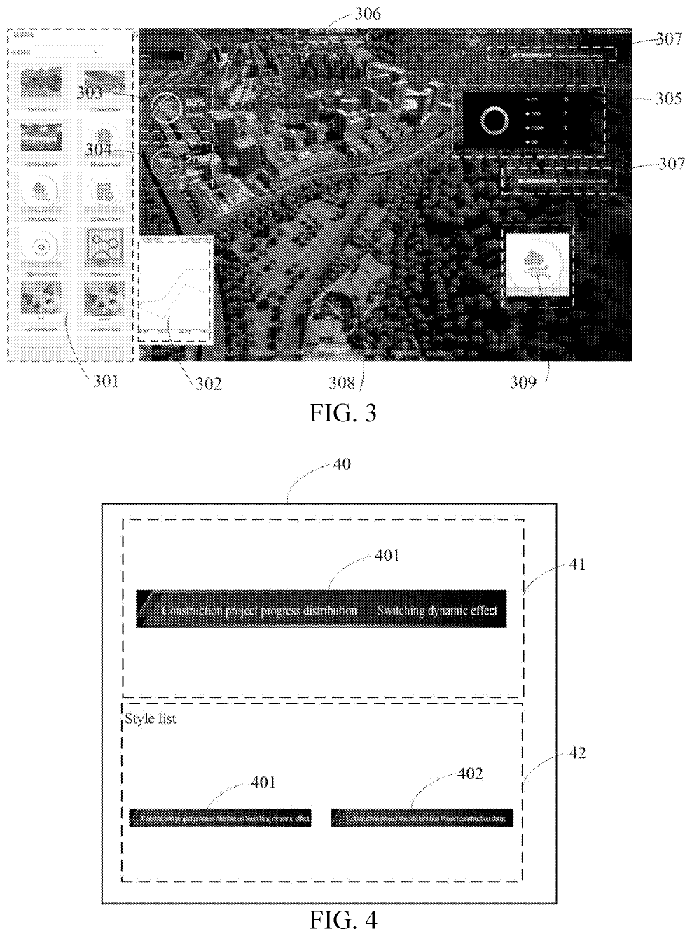

For example, as shown in FIG. 3, a page shown in a page design image 30 may include: nine panels, which are respectively a list panel for displaying different panels, a line chart panel for displaying a safety risk, a first annular scale distribution panel for displaying a construction progress of a main body structure, a second annular scale distribution panel for displaying a construction progress of decoration, a third annular scale distribution panel for displaying a construction project state distribution, a first title panel for displaying a park name, a second title panel for displaying a name of the first annular scale distribution panel, a first picture panel for displaying park weather, and a second picture panel for displaying a park picture. That is, the page design image 30 may include nine pieces of panel image information, which are respectively image information 301 of the list panel, image information 302 of the line chart panel, image information 303 of the first annular scale distribution panel, image information 304 of the second annular scale distribution panel, image information 305 of the third annular scale distribution panel, image information 306 of the first title panel, image information 307 of the second title panel, image information 308 of the second picture panel, and image information 309 of the first picture panel. Among them, in FIG. 3, panel image information is represented by an image region circled by a dashed line box.

For example, as shown in FIG. 4, a display interface 40 of a title panel is a display diagram of the title panel in the panel library in a visualized configuration system. The display interface 40 of the title panel may include: a first region 41 and a second region 42 disposed sequentially. In the first region 41, a title panel 401 with a first style is displayed in an enlarged manner so as to facilitate a user in visually configuring the title panel 401 with the first style, and in the second region 42, the title panel 401 with the first style and a title panel 402 with a second style are displayed in a list manner. Here, in FIG. 4, illustration is made by taking two styles of panels displayed in the second region 42 as an example.

For example, as shown in FIG. 3 and FIG. 4, the image information 307 of the second title panel and the image information 308 of the third title panel in the page design image 30 both match the title panel 402 with the second style in the panel library. Therefore, the micro-program center may obtain the title panel 402 with the second style from the panel library as a target panel corresponding to the image information 307 of the second title panel and the image information 308 of the third title panel respectively.

For example, taking the page design image 30 shown in FIG. 3 as an example, after the micro-program center matches nine target panels from the panel library, the micro-program center may display the nine target panels through the visualized configuration system, so that a user may perform a configuration operation on at least part of the nine target panels, thereby a micro-program corresponding to the page design image 30 may be generated after configuration is completed.

In an exemplary embodiment, prior to the act 24, the above method may further include act 25 to act 26.

Act 25: if there is no panel that matches the panel image information in the panel library, obtaining a preset blank panel from the panel library, wherein the preset blank panel includes at least one of a preset blank text panel and a preset blank picture panel.

Act 26: generating a target panel based on the panel image information and the preset blank panel.

In a practical application, a panel in the page design image may be essentially represented as text and a picture. Therefore, when there is no matching panel in the panel library, for example, some icons, faces, and background images, quick layout may be performed with a picture panel or a text panel. Then, in an exemplary embodiment, the act 26 may include act 261 to act 263.

Act 261: determining whether panel type information is a text panel type.

Act 262: if the panel type information is a text panel type, extracting text information from the panel image information and inserting the text information into a preset blank text panel to generate a target panel.

Act 263: if the panel type information is not a text panel type, inserting the panel image information into a preset blank picture panel to generate a target panel.

Therefore, when there is no panel that matches the panel image information in the panel library, an unknown panel appearing in the page design image may be automatically generated in a manner of a text panel or a picture panel. Thus, a panel may be quickly generated without manual selection by a user, which can improve a development speed of a micro-program.

In an exemplary embodiment, the act 22 may include: act 221 to act 223.

Act 221: determining panel type information based on panel image information.

Act 222: searching, based on the panel type information, whether there is a panel that corresponds to the panel type information in a preset panel library.

Act 223: according to a search result, determining whether there is a panel that matches the panel image information in the preset panel library.

In an exemplary embodiment, the panel type information may include any one of a line chart panel type, a pie chart panel type, a list panel type, an annular scale distribution panel type, a title panel type, a carousel chart panel type, a system announcement panel type, and a text panel type. Here, the embodiment of the present disclosure is not limited thereto.

In an exemplary embodiment, THE act 221 may include: act 2211: performing image recognition on the panel image information to obtain panel type information.

For example, image recognition may be achieved by using a neural network model such as a Residual Network (ResNet) (for example, ResNet 18) series network model, a MobileNet series network model, an InceptionV3 series network model, or a Soft Stagewise Regression Network (SSR Net) model, which may achieve a function of image classification. Here, the embodiment of the present disclosure is not limited thereto.

In an exemplary embodiment, the act 2211 may include: preprocessing the panel image information; and performing image recognition on the processed panel image information to obtain panel type information.

For example, preprocessing may include any one or more of denoising processing, de-averaging processing, normalization processing, and image standardization processing. For example, for the denoising processing, any one or more of bilateral filtering, Gaussian filtering, binning denoising, K-Dimensional Tree (KD-Tree)-based denoising, PassThrough filtering, random sample consensus filtering, and statistical method-based denoising may be adopted. Here, the embodiment of the present disclosure is not limited thereto.

In an exemplary embodiment, prior to the act 2211, the act 221 may further include: act 2212: performing image segmentation on the page design image to obtain panel image information.

For example, for an image segmentation method, a segmentation algorithm based on image texture and color, or a matting model based on a deep learning algorithm, etc. may be adopted. Of course, another segmentation method may be adopted, as long as the panel image information can be segmented from the page design image, here the embodiment of the present disclosure is not limited thereto.

In addition, in the act 2212, in a process of segmenting the panel image information from the page design image, a relative position of each piece of panel image information in the page design image may be recorded, that is, a relative position of a panel in a page is recorded, which may be used for automatically generating layout information of the panel.

In an exemplary embodiment, the act 223 may include: when there is a panel that matches the panel type information of the panel image information in the panel library, it may be determined that there is a panel that matches the panel image information in the panel library. Or, when there is a panel that matches the panel type information of the panel image information in the panel library, it may be determined that there is a panel that matches the panel image information in the panel library.

In an exemplary embodiment, in the panel library, in addition to a preset panel, a corresponding relationship between the preset panel and panel type information may be stored, panel type information of the panel image information may be searched in the panel library, and when the panel type information of the panel image information is found, a panel matching the panel type information of the panel image information may be acquired from the panel library according to the corresponding relationship between the preset panel and the panel type information.

Of course, the panel library may provide other ways for searching a panel in addition to the above-listed way of searching a panel by using panel type information, for example, in a way of searching an image using an image, i.e., in the panel library, in addition to the preset panel, the corresponding relationship between the preset panel and the panel image information may also be stored. Here, the embodiment of the present disclosure is not limited thereto.

In an exemplary embodiment, the act 24 may include act 241 to act 242.

Act 241: displaying the target panel through the visualized configuration system.

Act 242: in response to a user operation, performing a configuration operation on the target panel through the visualized configuration system to generate a micro-program, wherein the configuration operation includes at least one of display parameter configuration, data bonding, event bonding, and component bonding.

In an exemplary embodiment, performing a display parameter configuration on a panel may refer to configuring an appearance of the panel, such as size, color, or font. Here, the embodiment of the present disclosure is not limited thereto.

In an exemplary embodiment, performing data bonding on a panel may refer to bonding panel content to the panel. For example, a user may manually input data displayed in the panel through the visualized configuration system, or the user may bond data provided by another data server to the panel through the visualized configuration system, for example, inputting title text to a title panel; and for example, bonding multiple data sources to a line chart panel. Here, the embodiment of the present disclosure is not limited thereto.

In an exemplary embodiment, performing event bonding on a panel may refer to bonding a jump event or a click event or the like to the panel. Here, the embodiment of the present disclosure is not limited thereto.

In an exemplary embodiment, performing component bonding on a panel may refer to bonding one or more components provided by the component center to the panel. The components may include, but are not limited to: a drop-down list box, a text input box, a button, a navigation bar (TabBar), a scroll bar, or a check box, etc. For example, as shown in FIG. 3, a drop-down list box may be bound to a target panel (i.e., a line chart panel) corresponding to the image information 302 of the line chart panel, thus in a process of using an application, a user who views a line chart may select data that the user is more concerned about through the drop-down list box, so that the line chart panel only displays the data that the user is more concerned about.

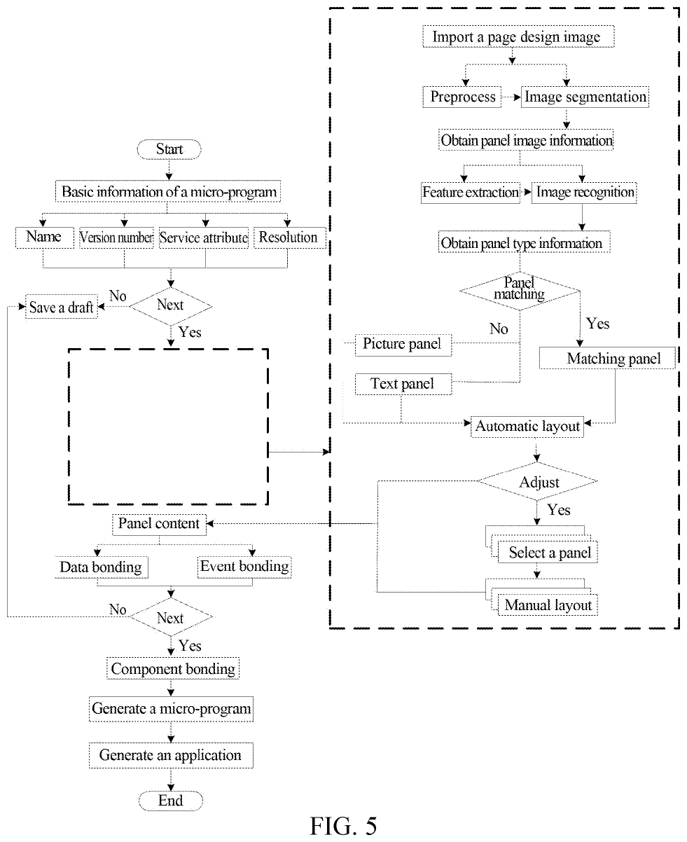

FIG. 5 is a second flowchart of a micro-program generation method according to an exemplary embodiment of the present disclosure. As shown in FIG. 5, the micro-program generation method may include following acts.

(1) A project template is constructed through a micro-program center, and basic information of a micro-program to be generated is set, wherein the basic information may include: a name, a version number, an application type, a resolution, or a service attribute, etc.

(2) Whether it is a micro-program generation process is determined through the micro-program center, if not, draft data of the micro-program is stored; and if yes, following micro-program generation processes may be executed.

(3) At least one page design image is introduced through the micro-program center, wherein the page design image may include at least one piece of panel image information.

(4) Through the micro-program center, for each page design image, image preprocessing is performed on the page design image, and image segmentation is performed on the preprocessed image, or image segmentation is directly performed on the page design image to obtain at least one piece of panel image information.

(5) Through the micro-program center, for each piece of panel image information, image feature extraction is performed on the panel image information, or image classification is performed on the panel image information to obtain panel type information.

(6) For the panel type information corresponding to each piece of panel image information, search is performed in the panel library with the panel type information through the micro-program center to find out whether there is a panel matching the panel type information, i.e., to find out whether there is a panel matching the panel image information. If there is a matching panel, the matching panel is acquired as a target panel for layout. If there is a matching panel, segmented panel image information is directly embedded in a visual picture panel, or text information in segmented panel image information is embedded in a visual text panel to generate a target panel for layout.

At this point, a process of determining the target panel in the micro-program to be generated based on the page design image is completed. Next, after determining a target panel corresponding to all panel image information in the page design image, the target panel may be visually configured through the visualized configuration system to generate a micro-program.

(7) For each target panel, on the visualized configuration system, the target panel is laid out on the page by dragging the target panel.

(8) For each target panel, at least one of display parameter configuration, event bonding, data bonding, and component bonding is performed for the target panel through the visualized configuration system to improve a function of each panel. Among them, event bonding may include: jump time or click event, etc., data bonding may include: manually inputting data or pulling data from a server interface for data bonding, and component bonding may include: bonding a drop-down list box, a text input box, a button, a navigation bar (TabBar), a scroll bar, or a check box, etc.

(9) A micro-program is generated through the visualized configuration system, wherein a data format of the micro-program may be a DSL-JSON data format, and a DSL-JSON file of the micro-program may include, but is not limited to: basic information of the micro-program, JSON data (i.e., strings describing panels) of all panels in the page, layout information of the page, and visual configuration screenshots of the micro-program. Among them, the layout information of the page may include: position information of each panel in the page, hierarchical structure information between all panels in the page, or hierarchical structure information between multiple pages, etc.

At this point, a process of generating the micro-program is completed, and the generated micro-program may be stored in the micro-program center, which facilitates subsequent generation of a corresponding cross-platform application. In this way, a process of converting the page design image into the micro-program is achieved.

(10) When creating a product, a corresponding micro-program may be selected to automatically package to generate an application suitable for a required application type, for example, an application suitable for a platform such as IOS, Android, Web, Windows, macOS, or Linux. In this way, a process of converting the page design image into an application is achieved.

The above process is illustrated by taking a process of generating a micro-program and an application with one page design image as an example. In a practical application, the micro-program center in the application development platform provided by the exemplary embodiment of the present disclosure may also import multiple page design images at one time, and correspondingly a micro-program composed of panels in multiple pages is generated, which may be understood by those skilled in the art with reference to the above contents and will not be repeated here. At this time, in addition to basic information of the micro-program, JSON data (i.e., strings describing panels) of all panels in each page, position information of each panel in a page, and hierarchical structure information between all panels in the page, the micro-program may further include: hierarchical structure information between multiple pages. The hierarchical structure information between multiple pages may be generated automatically in an order of imported page design images, or may be generated based on subsequent manual page adjustment through the visualized configuration system, for example, different pages are placed in a same TabBar, or different pages are opened within a range of different click events.

Description of the above application scenario embodiment is similar to description of the embodiment of the micro-program generation method, and has similar beneficial effects as the method embodiment. Technical details that are not disclosed in of the application scenario embodiment of the present disclosure will be understood by those skilled in the art with reference to the description in the method embodiment of the present disclosure and will not be repeated here.

An embodiment of the present disclosure also provides a computer device. The computer device may include: a processor and a memory storing a computer program that is runnable on the processor, wherein acts of the micro-program generation method in one or more exemplary embodiments described above are implemented when the processor executes the computer program.

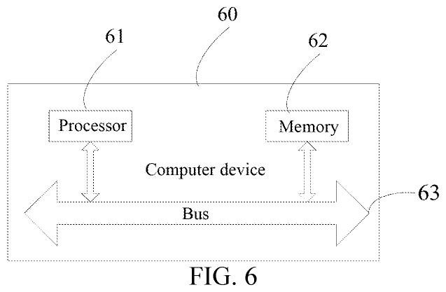

In an exemplary embodiment, as shown in FIG. 6, a computer device 60 may include: at least one processor 61; and at least one memory 62 and a bus 63 connected with the processor 61; wherein the processor 61 and the memory 62 communicate with each other through the bus 63; the processor 61 is used for calling program instructions in the memory 62 to execute the acts of the micro-program generation method in one or more exemplary embodiments described above.

In an exemplary embodiment, the above processor may be a Central Processing Unit (CPU), another general-purpose processor, a Digital Signal Processor (DSP), a Field Programmable Gate Array (FPGA) or another programmable logic device, a discrete gate or a transistor logic device, a discrete hardware component, an application specific integrated circuit, etc. The general-purpose processor may be a Micro Processor Unit (MPU) or any conventional processor, etc. Here, the embodiment of the present disclosure is not limited thereto.

In an exemplary embodiment, the memory may include a non-permanent memory in a computer-readable storage medium, a Random Access Memory (RAM) and/or a non-volatile memory, etc., such as a Read Only Memory (ROM) or a Flash RAM, and the memory includes at least one memory chip. Here, the embodiment of the present disclosure is not limited thereto.

In an exemplary embodiment, in addition to a data bus, the bus may further include a power bus, a control bus, a status signal bus, and the like. However, for clarity of illustration, multiple buses are labeled as the bus 63 in FIG. 6. Here, the embodiment of the present disclosure is not limited thereto.

In an exemplary embodiment, the computer device may further include, but is not limited to, a following component: an image acquisition unit, a voice playback unit, etc. For example, the image acquisition unit may be configured to acquire an image of a material (including marking information). For example, the image acquisition unit may include, but is not limited to, at least one camera, etc. For example, the voice playback unit may be configured to play alarm information. For example, the voice playback unit may include, but is not limited to, at least one speaker, etc.

In an implementation process, processing performed by the computer device may be completed by an integrated logic circuit of hardware in the processor or instructions in a form of software. That is, acts of the method in the embodiment of the present disclosure may be embodied as being executed and completed by a hardware processor, or executed and completed using a combination of hardware in the processor and a software module. The software module may be located in a storage medium such as a random access memory, a flash memory, a read only memory, a programmable read only memory or an electrically erasable programmable memory, a register, etc. The storage medium is located in the memory, and the processor reads information in the memory and completes the acts of the foregoing method in combination with hardware thereof. In order to avoid repetition, detailed description will not be provided here.

An embodiment of the present disclosure also provides a computer-readable storage medium, including a stored program, wherein acts of the micro-program generation method in one or more exemplary embodiments described above are implemented when the program is run. For example, when the program is run, a device where the storage medium is located is controlled to execute the acts of the micro-program generation method in one or more exemplary embodiments described above.

In an exemplary embodiment, the above computer-readable storage medium may include, but is not limited to use of: a ROM/RAM, a magnetic disk, or an optical disk, etc. Here, the embodiment of the present disclosure is not limited thereto.

Description of embodiments of the above computer device or computer-readable storage medium is similar to description of the above method embodiment, and has similar beneficial effects as the method embodiment. Technical details that are not disclosed in the embodiments of the computer device or computer-readable storage medium of the present disclosure will be understood by those skilled in the art with reference to the description of the method embodiment of the present disclosure and will not be repeated here.

It may be understood by those of ordinary skills in the art that all or some acts in the method disclosed above and function modules/units in a system and an apparatus may be implemented as software, firmware, hardware, and appropriate combinations thereof. In a hardware implementation mode, division of the function modules/units mentioned in the above description is not always corresponding to division of physical components. For example, one physical component may have multiple functions, or one function or act may be executed by several physical components in cooperation. Some components or all components may be implemented as software executed by a processor such as a digital signal processor or a microprocessor, or implemented as hardware, or implemented as an integrated circuit such as an application specific integrated circuit. Such software may be distributed on a computer-readable medium, and the computer-readable medium may include a computer storage medium (or a non-transitory medium) and a communication medium (or a transitory medium). As known to those of ordinary skills in the art, a term computer storage medium includes volatile and nonvolatile, and removable and irremovable media implemented in any method or technology for storing information (for example, a computer-readable instruction, a data structure, a program module, or other data). The computer storage medium includes, but is not limited to, a RAM, a ROM, an Electrically Erasable Programmable Read Only Memory (EEPROM), a flash memory or another memory technology, a Compact Disk Read Only Memory (CD-ROM), a Digital Versatile Disk (DVD) or another optical disk storage, a magnetic cassette, a magnetic tape, magnetic disk storage or another magnetic storage apparatus, or any other medium that may be used for storing desired information and may be accessed by a computer. In addition, as is known to those of ordinary skills in the art, the communication medium usually contains a computer-readable instruction, a data structure, a program module, or other data in a modulated data signal, such as a carrier wave or another transmission mechanism, and may include any information delivery medium.

Although implementation modes disclosed in the present disclosure are described as above, the described contents are only implementation modes which are adopted in order to facilitate understanding of the present disclosure, and are not intended to limit the present disclosure. Any skilled person in the art to which the present disclosure pertains may make any modification and alteration in a form and details of implementation without departing from the spirit and scope of the present disclosure. However, the patent protection scope of the present disclosure should be subject to the scope defined in the appended claims.

1. An application development platform, comprising: a panel library, a micro-program center, and a visualized configuration system, wherein
the panel library is configured to store a panel; and
the micro-program center is configured to obtain a page design image comprising panel image information; determine whether there is a panel that matches the panel image information in the panel library; if there is a panel that matches the panel image information in the panel library, acquire the panel that matches the panel image information as a target panel; and generate a micro-program based on the target panel through the visualized configuration system.

2. The platform according to claim 1, further comprising: a component center configured to store a component;
the micro-program center is configured to display the target panel through the visualized configuration system; and perform a configuration operation on the target panel in response to a user operation to generate the micro-program, wherein the configuration operation comprises at least one of display parameter configuration, data bonding, event bonding, and component bonding.

3. The platform according to claim 1, wherein the micro-program center is further configured to acquire a preset blank panel from the panel library if there is no panel that matches the panel image information in the panel library, the preset blank panel comprising at least one of a preset blank text panel and a preset blank picture panel; and generate the target panel based on the panel image information and the preset blank panel.

4. The platform according to claim 3, wherein the micro-program center is further configured to determine panel type information based on the panel image information; based on the panel type information, search whether there is a panel that corresponds to the panel type information in a preset panel library; and according to a search result, determine whether there is a panel that matches the panel image information in the preset panel library.

5. The platform according to claim 4, wherein the micro-program center is further configured to determine whether the panel type information is a text panel type; if the panel type information is a text panel type, extract text information from the panel image information and insert the text information into a preset blank text panel to generate the target panel; and if the panel type information is not a text panel type, insert the panel image information into a preset blank picture panel to generate the target panel.

6. The platform according to claim 1, further comprising: a product center configured to package the micro-program to generate a cross-platform application; wherein when the cross-platform application is run in different operating systems, a page comprising the target panel that is suitable for the different operating systems is generated.

7. A micro-program generation method, which is applied to an application development platform, wherein the method comprises:
obtaining a page design image comprising panel image information;
determining whether there is a panel that matches the panel image information in a panel library;
if there is a panel that matches the panel image information in the panel library, acquiring the panel that matches the panel image information as a target panel; and
generating a micro-program based on the target panel through a visualized configuration system.

8. The method according to claim 7, wherein the generating the micro-program based on the target panel through the visualized configuration system comprises:
displaying the target panel through the visualized configuration system; and
in response to a user operation, performing a configuration operation on the target panel through the visualized configuration system to generate the micro-program, wherein the configuration operation comprises at least one of display parameter configuration, data bonding, event bonding, and component bonding.

9. The method according to claim 7, wherein a data format of the micro-program is a JavaScript Object Notation (JSON) data format based on Domain Specific Language (DSL) description.

10. The method according to claim 7, further comprising:
if there is no panel that matches the panel image information in the panel library, acquiring a preset blank panel from the panel library, the preset blank panel comprising: at least one of a preset blank text panel and a preset blank picture panel; and generating the target panel based on the panel image information and the preset blank panel.

11. The method according to claim 10, wherein the determining whether there is the panel that matches the panel image information in the panel library comprises:
determining panel type information based on the panel image information;
searching, based on the panel type information, whether there is a panel that corresponds to the panel type information in a preset panel library; and
according to a search result, determining whether there is a panel that matches the panel image information in the preset panel library.

12. The method according to claim 11, wherein the generating the target panel based on the panel image information and the preset blank panel comprises:
determining whether the panel type information is a text panel type;
if the panel type information is a text panel type, extracting text information from the panel image information and inserting the text information into a preset blank text panel to generate the target panel; and
if the panel type information is not a text panel type, inserting the panel image information into a preset blank picture panel to generate the target panel.

13. The method according to claim 11, the determining the panel type information based on the panel image information comprises:
performing image segmentation on the page design image to obtain the panel image information; and
performing image recognition on the panel image information to obtain the panel type information.

14. A computer device, comprising: a processor and a memory storing a computer program that is runnable on the processor, wherein acts of a micro-program generation method according to claim 7 are implemented when the processor executes the program.

15. A non-transitory computer-readable storage medium, comprising a stored program, wherein acts of a micro-program generation method according to claim 7 are implemented when the program is run.

16. The platform according to claim 2, wherein the micro-program center is further configured to acquire a preset blank panel from the panel library if there is no panel that matches the panel image information in the panel library, the preset blank panel comprising at least one of a preset blank text panel and a preset blank picture panel; and generate the target panel based on the panel image information and the preset blank panel.

17. The method according to claim 8, further comprising:
if there is no panel that matches the panel image information in the panel library, acquiring a preset blank panel from the panel library, the preset blank panel comprising: at least one of a preset blank text panel and a preset blank picture panel; and generating the target panel based on the panel image information and the preset blank panel.

18. The method according to claim 9, further comprising:
if there is no panel that matches the panel image information in the panel library, acquiring a preset blank panel from the panel library, the preset blank panel comprising: at least one of a preset blank text panel and a preset blank picture panel; and generating the target panel based on the panel image information and the preset blank panel.

19. A computer device, comprising: a processor and a memory storing a computer program that is runnable on the processor, wherein acts of a micro-program generation method according to claim 8 are implemented when the processor executes the program.

20. A computer device, comprising: a processor and a memory storing a computer program that is runnable on the processor, wherein acts of a micro-program generation method according to claim 9 are implemented when the processor executes the program.
